(19) United States
(12) Patent Application Publication
(10) Pub. No.: US 2025/0310259 A1
(43) Pub. Date: Oct. 2, 2025

(54) PROGRAMMABLE CONGESTION MONITORING AND/OR CONTROL

(71) Applicant: Xilinx, Inc., San Jose, CA (US)

(72) Inventors: David Riddoch, Cambridge (GB); Ripduman Sohan, San Jose, CA (US); Steven Leslie Pope, Cambridge (GB)

(73) Assignee: Xilinx, Inc., San Jose, CA (US)

(21) Appl. No.: 18/620,776

(22) Filed: Mar. 28, 2024

(51) Int. Cl. H04L 47/12

(52) U.S. Cl. CPC H04L 47/12

(57) ABSTRACT

Described herein are systems and methods for programmable, hardware-accelerated congestion monitoring and/or control. At least one circuit can configure a plurality of hardware circuits with one or more rules that, when satisfied, cause the plurality of hardware circuits to generate one or more congestion events indicative of congestion in a network. The at least one circuit can receive the one or more congestion events generated by the plurality of hardware circuits based on one or more network signals in the network satisfying the one or more rules. In response to receipt of the one or more congestion events from the plurality of hardware circuits configured with the one or more rules to detect the congestion in the network, the at least one circuit can analyze the one or more congestion events to address the congestion in the network. Various other methods, systems, and computer-readable media are also disclosed.

### BACKGROUND

Messages can be transmitted among different devices or among various hardware and software components with different capabilities and/or functionalities. Such messages may be transmitted over a network in some cases, such as a network-on-a-chip (NoC), a wired communication network, a wireless communication network, or other physical layer. A variety of network protocols may be used.

### BRIEF DESCRIPTION OF THE DRAWINGS

The accompanying drawings illustrate a number of example implementations and are a part of the specification. Together with the following description, these drawings demonstrate and explain various principles of the present disclosure.

FIG. 1 is a block diagram of an example system in which configurable congestion monitoring and/or control can be used.

FIGS. 2A and 2B are block diagrams of example implementations of the illustrative system of FIG. 1.

FIG. 3 is a block diagram of a computer system with which some implementations can operate.

FIG. 4 is a flow diagram of an example method for configuring and using configurable congestion monitoring and/or control.

FIG. 5 is a flow diagram of an example method for processing congestion events in some systems implementing configurable congestion monitoring and/or control.

FIG. 6 is another flow diagram of another example method for processing congestion events in some systems implementing configurable congestion monitoring and/or control.

Throughout the drawings, identical reference characters and descriptions indicate similar, but not necessarily identical, elements. While the example implementations described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION

Described herein are examples of systems and methods for congestion monitoring and/or control that in some cases can leverage firmware and/or hardware to support hardware-speed congestion control while offering the flexibility to configure network hardware (e.g., a network interface card (NIC) or other network device) with different congestion control algorithms, such as algorithms that are newly developed or algorithms with which the network hardware was not or could not be previously used. For example, in some implementations, hardware can be used to perform operations related to congestion control across different algorithms, and congestion control algorithms can be loaded in firmware and/or software on the NIC and interface with that hardware via a hardware application programming interface (API), such that use of the algorithms by the hardware can leverage hardware-speed operations. In some implementations that leverage a hardware API or other hardware interface, the hardware API or other hardware interface can be used in some cases to notify network nodes (e.g., network devices, computing devices, or entities on the network, such as processors executing on one or more computing devices) about the congestion. Such a notification may be made in the form of a congestion event, or other notification. In some such cases, the firmware can control hardware primitives such as timers and counters to control congestion of the network over which connections are formed and in which congestion can arise.

Some examples described herein include systems and methods for congestion monitoring and/or control, in which at least one circuit can configure a plurality of hardware circuits with one or more rules that, when satisfied, cause the plurality of hardware circuits to generate one or more congestion events indicative of congestion in a network. The at least one circuit can receive the one or more congestion events generated by the plurality of hardware circuits based on one or more network signals in the network satisfying the one or more triggers for congestion event generation, where the triggers may be associated with one or more rules that, when met, indicate that a congestion event should be generated. In response to receipt of the one or more congestion events from the plurality of hardware circuits configured with the one or more rules to detect the congestion in the network, the at least one circuit can analyze the one or more congestion events to determine whether congestion is present in the network and/or to control or otherwise address that congestion. Various other methods, systems, and computer-readable media are also disclosed.

Attempts have previously been made at congestion control for a network. The inventors have recognized and appreciated in prior solutions congestion control was often performed in software on a host device or, in some cases, in a network interface card (NIC) or other network device of the host device.

The inventors have realized that hardware-based congestion control can be faster than traditional software- or firmware-based congestion control. Hardware implementations have previously been created, but conventional approaches to hardware-based congestion control were disadvantageous. Hardware implementation meant that congestion control algorithms were fixed in the hardware. Being fixed meant that congestion control algorithms implemented in the hardware could not be updated to change the configuration of the algorithm or update to another algorithm. This limited the utility of hardware acceleration as congestion control users sought flexibility to adjust configuration. To obtain such flexibility, users chose software- and firmware-based solutions and did not leverage hardware acceleration and did not obtain the benefits of hardware acceleration.

Described herein are examples of techniques for configurable congestion monitoring and/or control for a network. Such techniques can in some cases leverage a combination of hardware, firmware, and/or software for congestion control. In some implementations, software and/or firmware can access hardware circuits to perform some operations related to congestion control, and can implement new or updated congestion control algorithms in software and/or firmware as well as by performing those operations with the hardware circuits, so as to benefit from hardware speed while achieving flexibility for changing/updating congestion control algorithms. In some implementations, an interface between the software/firmware and the hardware can be a hardware application programming interface (API). In some such implementations, software and/or firmware can via the hardware API control scheduling and rules for generating and processing congestion events, and the firmware can via the hardware API configure the hardware circuits to perform congestion-related operations such as identifying congestion in peer nodes and the network. For example, the firmware can configure the hardware with rules for identifying one or more network signals as indicator(s) of congestion that could trigger generation of a congestion event. The hardware could include, in some implementations, timers, counters, or other circuits to evaluate network traffic and may be configured to analyze transmission rates, packet receipts, and network metrics such as round-trip time and latency, among other potential signals of congestion. The hardware may, upon determining in connection with its configuration that a signal of congestion has been detected, generate a congestion event.

In some implementations, techniques described herein can enable NICs or other network devices to be configured with new and/or updated congestion control algorithms while leveraging the speed advantages of hardware. Such updates can enable NICs or other network devices to use new and/or updated congestion control algorithms to support high-performance and low turn-around time communications. For example, a new and/or updated congestion control algorithm in some implementations may be an algorithm that can manage congestion in the presence of multipath-capable network protocol, while another congestion control algorithm (e.g., an existing algorithm, or a different new algorithm) may not be able to manage congestion for a multipath-capable network protocol. As new and/or updated algorithms are configured, the signals of and responses to congestion may be set based on the network protocols and/or congestion control algorithms in accordance with techniques described herein. Such updates can also include security patches, such as changes to protect against malicious actors in a network and/or to address security risks that have been detected in previously-released congestion control algorithms or other software/firmware.

As will be described in greater detail below, the present disclosure describes various systems and methods for congestion monitoring and/or control.

In some implementations, there is provided a system comprising at least one circuit configured to configure a plurality of hardware circuits with one or more rules that, when satisfied, cause the plurality of hardware circuits to generate one or more congestion events indicative of congestion in a network; receive the one or more congestion events generated by the plurality of hardware circuits based on one or more network signals in the network satisfying the one or more rules; and, in response to the receipt of the one or more congestion events from the plurality of hardware circuits configured with the one or more rules to detect the congestion in the network, analyze the one or more congestion events to address the congestion in the network.

In some such implementations, the at least one circuit is configured to configure the plurality of hardware circuits to generate the one or more congestion events at least in part by configuring at least one of the plurality of hardware circuits to output an indication of congestion in response to detecting that one or more packets received over the network satisfy one or more criteria.

In some such implementations, the at least one circuit is configured to configure the plurality of hardware circuits to generate the one or more congestion events at least in part by configuring at least one of the plurality of hardware circuits to output an indication of congestion in response to detecting that a connection satisfies one or more criteria.

In some such implementations, configuring the at least one of the plurality of hardware circuits to output the indication of congestion in response to detecting that the connection satisfies one or more criteria comprises configuring at least one of the plurality of hardware circuits to output an indication of congestion in response to determining, based on an analysis of a plurality of packets of the connection, that the one or more criteria are satisfied.

In some such implementations, the at least one circuit is configured to configure the plurality of hardware circuits at least in part by configuring at least one of the plurality of hardware circuits to output an indication of congestion in response to a timer satisfying at least one criterion.

In some such implementations, the at least one circuit is configured to configure the plurality of hardware circuits at least in part by configuring the at least one of the plurality of hardware circuits to start the timer upon satisfaction of at least one second criterion.

In some such implementations, the at least one circuit is configured to configure the plurality of hardware circuits to generate the one or more congestion events at least in part by configuring at least one of the plurality of hardware circuits to generate a congestion event in response to detecting that one or more storages of the system, for storing information regarding messages communicated over the network, satisfy one or more criteria.

In some such implementations, configuring the at least one of the plurality of hardware circuits to generate the congestion event in response to detecting that the one or more storages of the system satisfy the one or more criteria comprises configuring the at least one of the plurality of hardware circuits to generate the congestion event in response to detecting that the one or more storages of the system are filled more than a threshold amount.

In some such implementations, the at least one circuit is configured to analyze the one or more congestion events at least in part by identifying, in the one or more congestion events, a storage in which the one or more congestion events are to be stored; and when the storage is not available for storage of the one or more congestion events, deleting the one or more congestion events of a first type; or triggering at least one of the plurality of hardware circuits to prevent generation of additional congestion events of a second type.

In some such implementations, the at least one circuit is further configured to transmit over the network to a source of one or more network communications an indication of the congestion in the network, responsive to the one or more congestion events being indicative of congestion.

In some such implementations, the at least one circuit is further configured to provide to one or more of the plurality of hardware circuits information regarding congestion, responsive to the one or more congestion events indicating congestion with respect to a connection over the network.

In some implementations, there is provided a network interface hardware to provide connectivity between a host and a network. The network interface hardware comprises at least one circuit configured to configure a plurality of hardware circuits with one or more rules that, when satisfied, cause the plurality of hardware circuits to generate one or more congestion events indicative of congestion in a network; receive the one or more congestion events generated by the plurality of hardware circuits based on one or more network signals in the network satisfying the one or more rules; and in response to receipt of the one or more congestion events from the plurality of hardware circuits configured with the one or more rules to detect the congestion in the network, analyze the one or more congestion events to address the congestion in the network.

Some such implementations may further include the host.

In some such implementations, the at least one circuit is configured to analyze the one or more congestion events at least in part by identifying, in the one or more congestion events, a storage in which the one or more congestion events are to be stored; and when the storage is not available for storage of the one or more congestion events, deleting the one or more congestion events of a first type; or triggering at least one of the plurality of hardware circuits to prevent generation of additional congestion events of a second type.

In some such implementations, configuring the plurality of hardware circuits to generate the one or more congestion events comprises configuring at least one of the plurality of hardware circuits to output an indication of congestion in response to detecting that a connection satisfies one or more criteria.

In some such implementations, configuring the plurality of hardware circuits comprises configuring at least one of the plurality of hardware circuits to output an indication of congestion in response to a timer satisfying at least one criterion.

Some implementations include a method for congestion control that is performed with at least one circuit. The method comprises receiving one or more congestion events generated by a plurality of hardware circuits configured with one or more rules for generating the one or more congestion events in response to detecting one or more network signals in a network; and, in response to identifying that the one or more congestion events cannot be processed to address congestion in the network, identifying, based on the one or more congestion events, whether to drop the one or more congestion events or modify generation of the one or more congestion events.

In some such implementations, identifying that the one or more congestion events cannot be processed comprises identifying, in the one or more congestion events, availability of memory to which the one or more congestion events are addressed for storage; and identifying, based on unavailability of the memory, that the one or more congestion events cannot be processed.

In some such implementations, identifying whether to drop the one or more congestion events or modify generation of the one or more congestion events comprises identifying whether the one or more congestion events are of a first type that can be deleted or a second type that cannot be deleted; in a first case that the one or more congestion events are of the first type, delete the one or more congestion events; or in a second case that the one or more congestion events are of the second type, configuring the plurality of hardware circuits to modify generation of the one or more congestion events.

In some such implementations, modifying the generation of the one or more congestion events comprises configuring the plurality of hardware circuits to modify a generation rate of the one or more congestion events.

Some implementations include a method for congestion control that is performed with at least one circuit. The method comprises receiving one or more congestion events generated by a plurality of hardware circuits configured with one or more rules for generating the one or more congestion events in response to detecting one or more network signals in a network and, in response to the at least one circuit not being able to process the one or more congestion events to address congestion in the network, dropping the one or more congestion events or modifying generation of additional congestion events.

In some such implementations, the at least one circuit is not able to process the one or more congestion events due to unavailability of memory to which the one or more congestion events are addressed for storage.

In some such implementations, the at least one circuit drops the one or more congestion events responsive to the one or more congestion events being of a first type that can be deleted, and wherein the at least one circuit configures the plurality of hardware circuits to modify the generation of the additional congestion events responsive to the one or more congestion events being of a second type that cannot be deleted.

In some such implementations, modifying the generation of the additional congestion events comprises modifying a generation rate of the additional congestion events.

Features from any of the implementations described herein can be used in combination with one another in accordance with the principles described herein. These and other implementations, features, and advantages will be more fully understood upon reading the following detailed description in conjunction with the accompanying drawings and claims.

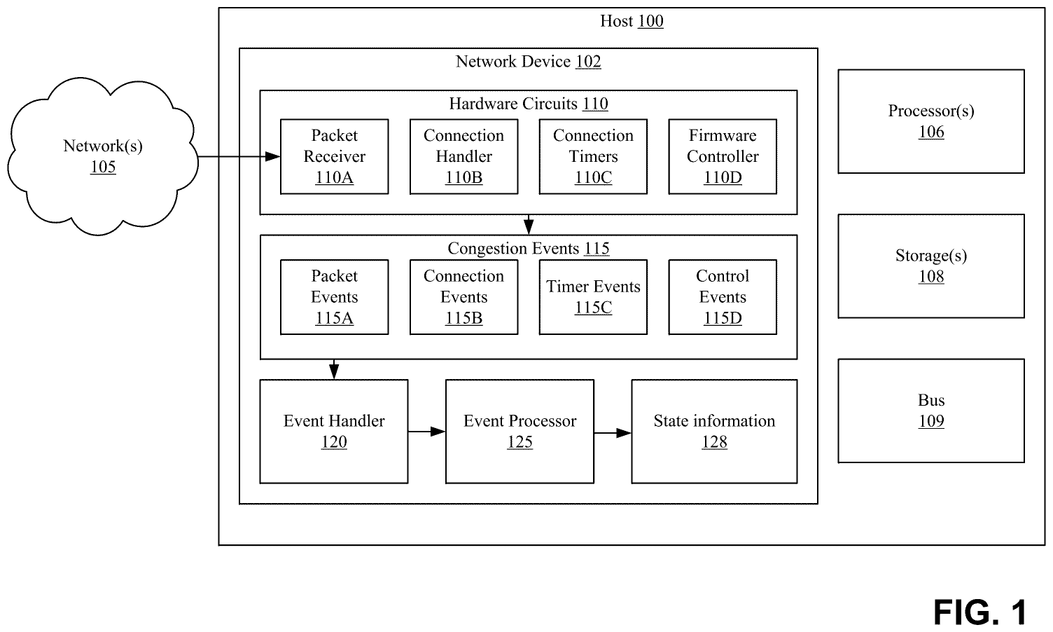

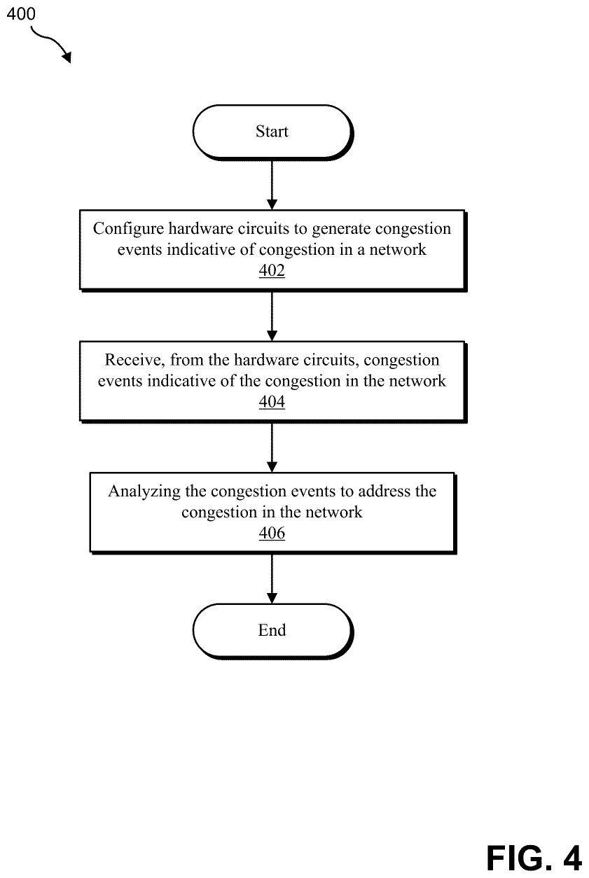

Below are provided, with reference to FIGS. 1-3, detailed descriptions of example systems for programmable, hardware-accelerated congestion monitoring and/or control. Detailed descriptions of examples of computer-implemented methods are also provided in connection with FIGS. 4-6. It should be appreciated that while example implementations are provided, other implementations are possible, and implementations are not limited to operating in accordance with the examples below.

FIG. 1 is a block diagram of an example host device 100 that includes a network device 102 that may be include hardware, firmware, and/or software for performing configurable congestion monitoring and/or control in accordance with techniques described herein. Host device 100 can be any suitable device for communicating over a network 105, as implementations are not limited in this respect. In some implementations, host device 100 can be a rack-mounted server or other rack-mounted computer, a network-attached storage, a desktop or laptop personal computer, a mobile device, or other computing device.

Host device 100 includes a network device 102, which can be a network interface card (NIC) or other hardware that enables host device 100 to communicate via network(s) 105. The network device 102 can communicate network messages (according to any suitable network protocol, as implementations are not limited in this respect) from host 100 to other nodes over the network(s) 105 and/or receive messages from network(s) 105 intended for host 100 (including one or more entities of host 100, such as processes that are endpoints for network communication), and can thus act to exchange data between host 100 and the network(s) 105. Network device 102 can include components to perform network protocol processing, such as physical layer operations such as to transmit and/or receive data via network(s) 105, link layer operations such as collision detection or avoidance and identifying whether received data is intended for the host 100, transport layer operations such as forming and/or maintaining connections and managing reliability of communication (e.g., error detection and/or resolution), or other operations related to enabling network communication.

Implementations are not limited to operating with any particular network(s) 105. In some implementations, network(s) 105 can be or include any suitable one or more wired and/or wireless, local- and/or wide-area computer communication networks, including one or more enterprise networks and/or the Internet. Generally speaking, network(s) 105 can generally represent any medium or architecture capable of facilitating communication or data transfer. Examples of the network 105 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

As illustrated in FIG. 1, host 100 can also include one or more processor(s) 106 to execute instructions to perform operations, such as executing applications or other processes that may communicate (e.g., send and/or receive) data over the network(s) 105 via the network device 102. Such processor(s) 106 can be any suitable single- and/or multicore processors, as implementations are not limited in this respect. Instructions and/or data to be processed by the processor(s) 106 can be stored in one or more storages 108, which can include any suitable form of volatile and/or non-volatile/persistent storage, including registers, caches, memory, hard drives (including hard disk drives (HDDs) and/or solid state drives (SSDs)), or other storage. The network device 102, processor(s) 106, and storage(s) 108 can, in some implementations, communicate with one another via a system bus 109, such as a Peripheral Component Interconnect (PCI) bus or other bus. For example, network device 102 can receive data from network(s) 105 in one or more messages (e.g., packets or other datagrams) and send that data to a storage 108 via the bus 109, to make the data available for processing by a process executing on a processor 106. As another example, network device 102 can receive data from a storage 108 via the bus 109, and receive a request to transmit the data via the network(s) 105 to a recipient.

While for ease of illustration, FIG. 1 does not show the network device 102 including registers, caches, or other storage, or other components of a network device (e.g., a NIC), those skilled in the art will understand that the network device 102 includes such components. In addition, while for ease of illustration and ease of description host 100 is illustrated and described as including one network device 102, it should be appreciated that a host 100 can include any suitable number of network devices 102, as implementations are not limited in this respect.

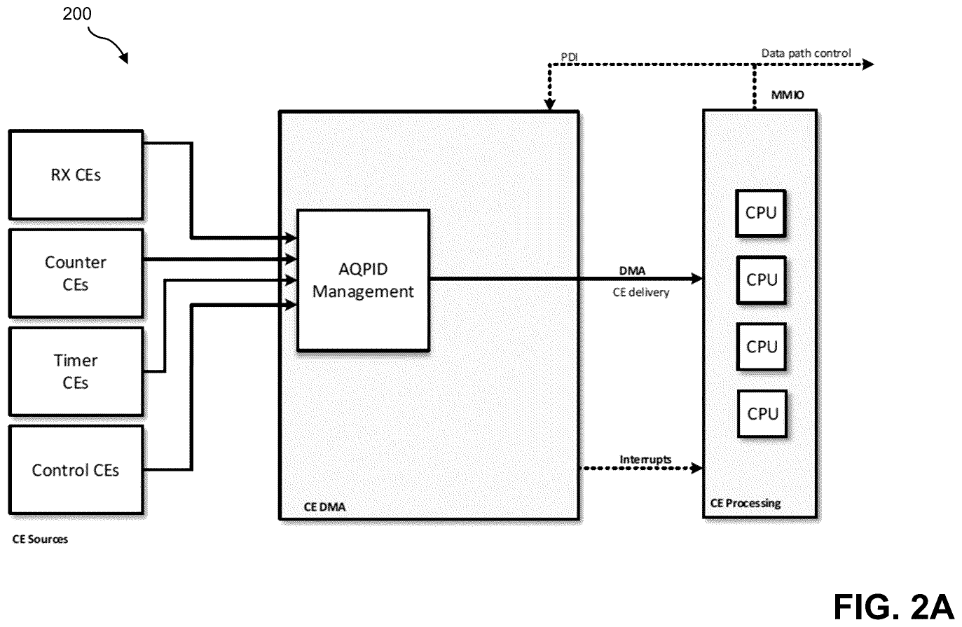

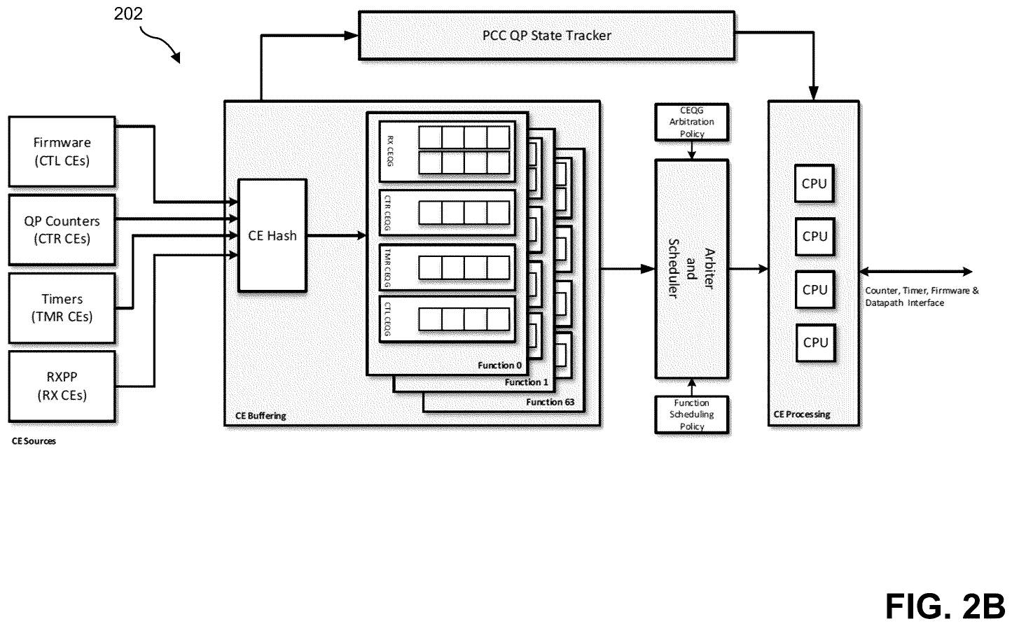

Network device 102 includes components to perform configurable congestion monitoring and/or control in accordance with techniques described herein. FIG. 1 illustrates examples of these components, as do FIGS. 2A-2B.

As should be appreciated from the foregoing, to enable congestion control to use hardware-speed operations, network device 102 includes one or more hardware circuits 110 to be configured and to perform operations related to analysis of network traffic and detection of indicators of potential network congestion, and to generate and output congestion events in response to such detection.

The hardware circuits 110 can be configured in accordance with techniques described herein to generate congestion events 115 that are indicative of potential congestion in one or more of the network(s) 105. The hardware circuits 110 may be configured per a congestion control algorithm, or one or more congestion control algorithms, to generate one or more congestion events 115 in response to detecting that network traffic satisfies one or more criteria (for any one or more of the congestion control algorithm(s) per which the circuits 110 are configured) that are indicative of potential congestion in the network(s) 105. Such congestion would be or include congestion on one or more paths between one or more entities with which host 100 is communicating over a network. It may be in some cases that some paths through the network(s) 105 are experiencing congestion at a time while at that time other paths through the network(s) 105 are not experiencing congestion, such that communications with entities, or some connections, may be experiencing congestion at a time that other communications/connections are not experiencing congestion.

Accordingly, in some implementations the hardware circuits 110 are configured in accordance with one or more congestion control algorithms to generate congestion events when criteria are met. The criteria may be specified by the algorithm and/or by a user configuration in accordance with the algorithm. The events may be in connection with occurrence of congestion or increasing congestion, and/or may be in connection with a lack of congestion or lessening congestion. As discussed in greater detail below, one or more event handlers 120 may receive congestion events 115 and prepare them for analysis by an event processor 125. Event processor 125 may make determinations in connection with one or more of the congestion control algorithm(s) of whether any one or a combination of congestion events 115 indicates congestion has occurred in connection with any communication with an entity or with any connection. (While some implementations may include both an event handler 120 and an event processor 125, other implementations may include a component that performs the functions described herein of both the event handler 120 and the event processor 125.) Such information on congestion, including whether congestion is occurring or whether congestion has been relieved, may in some implementations be used by event processor 125 to update state information 128 for one or more communications/connections. Network operations may then be adjusted based on the state information, such as by adjusting a rate of transmission, an amount of unacknowledged data to be sent, communicating indications of congestion to a sender of communications (in a case that congestion control is being done on a receiver side), or other known ways of updating network communications in response to the presence or absence of congestion. Additionally or alternatively, on-host and/or on-network device operations may be performed or adjusted, such as sending a message to a host (e.g., to an application or process executing on the host), starting a timer, or other operations.

In cases in which the circuits 110 are configured to operate with multiple congestion control algorithms concurrently, a criterion with which the circuits 110 are configured may be a criterion that is associated with only one of the algorithms, two or more of the algorithms, or all of the algorithms, as implementations are not limited in this respect. In addition, while FIG. 1 is illustrated as including multiple hardware circuits 110, in some implementations there may be only one hardware circuit 110. And while FIG. 1 illustrates different hardware circuits for different hardware operations (examples of which are discussed below), implementations are not so limited and in other implementations a hardware circuit 110 may perform two or more hardware operations, including by performing a combination of hardware operations illustrated as different hardware circuits in the example of FIG. 1. And, in some implementations any of the circuits 110 of FIG. 1 may be implemented as two or more circuits that perform the operations of one of the circuits 110. Or, while for ease of illustration FIG. 1 shows one circuit of each type 110A-110D, other implementations may have two or more of any of the circuits 110A-110D.

The techniques described herein are not generally limited to detecting congestion in connection with any particular network protocol. However, some techniques may be advantageous for use with particular network protocols. For example, some implementations are adapted for use with Remote Direct Memory Access (RDMA) (which as used herein includes RDMA Over Converged Ethernet (ROCE) or other versions or implementations of RDMA, and accompanying protocols). For example, the network device 102, including hardware circuits 110, can be configured with one or more congestion control algorithms to detect congestion events 115 in communications that are occurring using RDMA queue pairs (QPs). In some implementations, a mix of network messages are possible, such as processing packets including ROCE packets and switch telemetry packets together.

In some implementations, the hardware circuits 110 can be or include one or more circuits, such as a packet receiver 110A, a connection handler 110B, a connection timer 110C, and/or a firmware controller 110D. Each circuit 110A-110D may be configured to perform a hardware operation related to congestion monitoring and/or control. For example, each circuit 110A-110D may be adapted to perform in hardware (e.g., circuitry) one or more operations to analyze network traffic. The operation that the circuit 110A-110D is adapted to perform may be configurable in accordance with techniques described herein, such as by configuring one or more parameters of an operation. As a specific example, a circuit 110A-110D may be configured to perform an operation in connection with one or more rules, such as by generating an output when one or more conditions of a rule are met. The condition of a rule may be configurable via a hardware interface, such as a hardware API. For example, if a condition has a value, such as a threshold, then the value may be specified via the hardware API and the circuit 110A-110D may perform the operation in hardware in accordance with the configured rule.

The circuits 110A-110D of FIG. 1 are examples of different circuits and different hardware operations that may be used in some implementations to perform in hardware operations related to congestion monitoring and/or control. In some implementations, each of the circuits 110A-110D can be configured to perform a different kind of hardware operation. The circuits 110A-110D can also be configured to generate as output a different congestion event 115, such as congestions events 115A-115D. In some implementations, circuit 110A can generate a congestion event 115A upon satisfaction of one or more rules with which the circuit 110A can be configured, and the same may be respectively true of circuits 110B-110D and congestion events 115A-115D.

In some implementations, the packet receiver 110A can identify and/or track packet parameters of packets in the network 105 to generate packet events 115A. Packet parameters may be information determinable from an individual packet or a group of packets, such as packets received together from a source or to be sent together to a destination, and/or are for a connection. In some network protocols, a packet may include a flag or other value to signal that congestion has been detected in the network, such as a flag to indicate that a sender of the packet has determined that congestion exists between the sender and the recipient. An example of such a flag is an “IP CE” Explicit Congestion Notification (ECN) flag sent in a packet. Other parameters of packets may also be used as signals of congestion, as implementations are not limited in this respect. The packet receiver 110A may analyze received packets and, when one or more parameters are met by a packet or collection of packets, generate a packet event 115A. As one example of an implementation, a circuit 110A can include circuitry to determine whether a particular flag in a packet is set to a certain value or not, or whether a value in a packet exceeds a threshold, or whether another condition is met, and output a congestion event 115A in that event. In accordance with some implementations, such a circuit 110A may be configured with different values/thresholds such that the circuit 110A can be used with different congestion control algorithms (e.g., different values/thresholds for different algorithms, or set based on user preference or constraints for an application of a congestion control algorithm). While, for ease of description, circuit 110A and event 115A are described in the context of packets, it should be appreciated that implementations are not limited to packets and that other datagrams, other frames, or other message types may be used.

In some implementations, the connection handler 110B can identify, count, and/or track connection parameters of connections (e.g., RDMA and/or via QPs) via the network 105 to generate connection events 115B. The connection handler 110B may be adapted in hardware (e.g., as one or more circuits) to analyze information about a connection that may arise across multiple packets (or other messages, such as other datagrams) exchanged over a connection. The information about a connection may include, for example, maintaining a counter that is incremented and/or decremented as packets (or other messages) are received that either meet or do not meet a criterion. For example, if a packet for the connection meets a criterion or criteria, a counter may be incremented, and if a packet for the connection does not meet a criterion/criteria, the counter may be decremented. Other suitable techniques for maintaining a counter across messages exchanged over a connection may also be used, as implementations are not limited in this respect. As one example of an implementation, a circuit 110B can include circuitry to determine whether packet contents satisfy one or more criteria and output a congestion event 115A in that event. In accordance with some implementations, such a circuit 110B may be configured with different values/thresholds/criteria such that the circuit 110B can be used with different congestion control algorithms (e.g., different values/thresholds for different algorithms, or set based on user preference or constraints for an application of a congestion control algorithm). Accordingly, a connection handler 110B may analyze received packets for a connection over time and, when one or more criteria are met by a connection, generate a packet event 115B.

In some implementations, the connection timers 110C can identify, maintain, and/or track timers for the connections of the network 105 to generate connection events 115B. A timer may be set based on any suitable start criteria, such as related to transmission of a packet, receipt of a packet, or other criteria. A timer may also count to any suitable value, as embodiments are not limited in this respect. In some implementations, a circuit 110C may be adapted to start a timer upon occurrence of an event and to stop and reset the timer if another event occurs. If, however, the timer reaches a value (e.g., 0 in the case of a timer counting down from a configurable start value, or a configurable end value in the case of a timer counting up), then the circuit 110C may output a congestion event 115C. The criterion on which the timer starts and ends may be configurable, such as via a hardware API. As one example, a timer may start on transmission of a packet and be reset upon receipt of a corresponding acknowledgement, or a congestion event 115C may be output if the timer exceeds a value before receipt of the corresponding acknowledgement.

In some implementations, the firmware controller 110D can identify and/or track control signals to generate control events 115D. Control signals may be used to control a state of a datapath for incoming and/or outgoing messages. Operations that may be performed using control signals include allocation of resources or information regarding resources previously allocated. Control signals may indicate, for example, a status of a storage in which incoming or outgoing messages are stored during processing by network device 102. For example, a fill level of a storage may be indicated in a control signal that tells one or more components of the network device 102 whether more data can be written to the storage. While conventional congestion monitoring and control has focused on whether congestion is occurring in the network 105, congestion within a network device 102 has been conventionally overlooked. By analyzing the control signals within the network device 102 and regarding components of the device 102 (or otherwise within host 100), congestion within the host 100 or network device 102 may be monitored and addressed. A circuit 110D may be adapted (e.g., in circuitry) to receive control signals exchanged along a control path and/or data path within the network device 102 and determine whether the control signals satisfy one or more conditions, such as whether a value in a signal meets or exceeds a configurable value or whether control signal has a particular content. A hardware API may be used to set the conditions to be used by the circuit 110D. When the condition is met, the circuit 110D may output a congestion event 115D.

While each illustrated as a single circuit, those skilled in the art will appreciate that the hardware circuits 110 may each be implemented as one or more circuits. In addition, as will be discussed in further detail below, some implementations may include configuring the packet receiver 110A, the connection handler 110B, the connection timer 110C, and the firmware controller 110D differently from one another. For example, the circuits can be configured over time in accordance with one or more congestion control algorithms (one algorithm at a time, or multiple algorithms) to detect and generate congestion events 115 that can be handled by an event handler 120 and processed by an event processor 125 to determine, based on a congestion control algorithm, whether congestion is present. The configuration of the circuits 110 can be done in some implementations via a hardware API or other hardware interface. In some implementations, a component of the host 100 can perform the configuration. In some cases, it may be a component of the network device 102. For example, the event processor 125 may be configured to receive information regarding a congestion control algorithm, which may be information regarding one or more rules that can be used to trigger generation of congestion events. In accordance with the information regarding the congestion control algorithm, the event processor 125 may communicate to the hardware circuits 110, such as via a control bus or other signal path, to provide instructions to the circuits 110 via an interface (e.g., a hardware API). The event processor 125 may receive the information regarding the congestion control algorithm from any suitable source, including from another component of the host 100 (e.g., a process executing on processor(s) 106) or via the network 105 from an entity on the network. The event processor 125 may execute software to analyze received information regarding a congestion control algorithm and configure the circuits 110 and, based on the information, configure the circuits 110. In other implementations, rather than the event processor 125 doing the configuration, a process executing on processor(s) 106 may do the configuration via an interface of network device 102. In other implementations, another component of host 100 or network device 102 (implemented in hardware or a combination of hardware and software, such as instructions executing on a processor or microcontroller) can perform the configuration.

The hardware circuits 110 can represent any type or form of circuit hard-coded to perform certain operations and/or hardware-implemented processing unit capable of interpreting and/or executing computer-readable instructions. In one example, the hardware circuits 110 can generate and/or modify one or more bits of the congestion events 115 of the network device 102. In one example, the hardware circuits 110 can be accessed and/or modified by the network device 102. Additionally, or alternatively, the one or more of components of the network device 102 can configure the hardware circuits 110 for configurable congestion monitoring and/or control.

Examples of the hardware circuits 110 include, without limitation, Field-Programmable Gate Arrays (FPGAs) that implement softcore processors, Application-Specific Integrated Circuits (ASICs), portions of one or more of the same, variations or combinations of one or more of the same, or any other suitable circuit.

Congestion events 115 (e.g., packet events 115A, connection events 115B, timer events 115C, and/or control events 115D) can include any number of signals, packets, or computer-readable instructions that may indicate potential congestion explicitly or may be, following analysis of the congestion event alone or in context with other congestion events, determined to indicate presence of congestion in the network(s) 105.

As discussed above, techniques described herein may be used with a variety of network protocols and can, in some implementations, be used with a version of RDMA. In some such implementations, congestion events 115 can be generated in connection with potential congestion in a connection to which an RDMA queue pair (QP) relates, which may be a physical queue pair with physical resources reserved in a nonvolatile manner while an RDMA connection is open or may be a virtual queue pair for which physical resources are allocated and deallocated to the virtual queue pair over time while the RDMA connection is open. In some cases in which techniques described herein are used with RDMA, a congestion event 115 may indicate a QP to which a congestion event 115 relates, such as by identifying one queue of the QP, by identifying an RDMA connection, or otherwise indicating the QP. In some implementations, a congestion event 115 can include information related to the context of a QP or a configuration of a QP, or information related to QP configuration and working state. This may be any suitable information regarding a QP, as implementations are not limited in this respect.

In some implementations, congestion events 115 can include congestion state for the QP. In some implementations in which congestion events include congestion state, including the congestion state may aid in making processing of congestion events stateless as the event processor 125 (or other entity that processes the congestion event) does not need to separately maintain state information to be retrieved and used when processing a congestion event. This can improve scalability in some implementations, as there is less storage overhead and less resource usage when congestion state information is not separately accessed by the event processor 125 during processing of a congestion event. In some other implementations, in addition to or as an alternative to the congestion event itself including congestion state, a hardware circuit 110 may store congestion state information to be retrieved and used when evaluating a congestion event and determining how to respond to the congestion event. In either case, as discussed elsewhere herein, the event processor 125 may update state information 128 that is maintained for each connection or communication. State information 128 may indicate congestion state for a communication/connection and be used by one or more other components of the network device 102 to regulate communication, such as by using known techniques to control congestion when an event processor 125 updates the state information 128 to determine that congestion is present or is no longer present after being previously found to be present. In some implementations in which congestion state is stored in circuits 110 and included in congestion events 115 for processing by the event processor 125, once state information 128 is updated by event processor 125 the state information stored by the circuits 110 may be synchronized to the state information 128.

In some cases in which congestion state is stored by a circuit 110 and used in generating a congestion event, concerns may arise that stored congestion state information could become out of date in a situation in which congestion is arising. For example, circumstances could arise in which there may be a race condition between the time it takes to retrieve and/or update stored congestion state information in storage (e.g., a register, cache, memory, or other storage of or accessible by circuits 110) and the time that a new congestion event with new congestion information may arrive for processing. With such a race condition, while one congestion event is being processed with stored congestion information, another congestion event may arrive with new information regarding congestion state, leading to the first being processed with out of date congestion state information.

In some implementations, to mitigate risk of a potential race condition, a congestion event may include information, such as a flag, indicating whether the congestion event is for a communication exchange between a transmitter and a receiver (e.g., a connection) that is in active use. For example, in some such implementations, communication exchanges may be active or inactive, where an inactive communication exchange may be for a communication that has not yet been terminated but is less active than other communications. Moving some communication exchanges to an inactive status may aid in preserving resources for more active communication exchanges. In some such cases, when a congestion event is received for a communication that has been inactive, and there may be stored congestion state information for that communication, the inactive status may mean that the stored congestion information is outdated. Information for the congestion event may indicate that this is the first congestion event for a previously-inactive communication. Upon processing of that congestion event, the stored congestion state information may be discarded and replaced with congestion state information in the congestion event, and the congestion event's congestion state information is used in the processing of the congestion event. For other congestion events, the information regarding the communication may instead indicate that the communication is active. In this case, the congestion state information in the congestion event may be used to update the previously-stored congestion state information. The updated congestion state may be used to process the congestion event. In some implementations, congestion events 115 can include type-specific metadata (e.g., packet fields, timeout values or counter values).

Examples of the content included in the congestion events 115 include network data, payloads, addresses, definitions, headers, protocols, identifiers, checksum values, hashes or any other instructions received from a Network on Chip (NoC), Network Interface Card (NIC), user logic, or fabric adapter. The congestion events 115 can be configured to be transmitted among devices, data circuits, or other entities.

The event handler 120 can be an intermediary between the hardware circuits 110 and the event processor 125. The event handler 120 can facilitate provision of congestion events 115 from the hardware circuits 110 to the event processor 125. The event handler 120 can be or include any form of storage, including a buffer, register, memory banks, queue (e.g., first-in-first-out (FIFO) queue or other queue), memory Random Access Memory (RAM), cache, or any other type of storage. In some implementations, the event handler 120 may perform operations related to batching and merging congestion events.

When congestion events 115 are generated by circuits 110, the congestion events 115 may be provided from the circuits 110 to the event handler 120 and stored in the storage. For example, in some implementations the hardware circuits 110 may output a congestion event 115 directly to a storage of the event handler 120.

In other implementations, the event handler 120 may receive congestion events 115 and determine a storage in which to store the events 115, from among multiple storages of the handler 120. For example, the handler 120 may load balance the congestion events 115 between multiple storages. As another example, the handler 120 may store all congestion events 115 for a particular connection, a particular source-destination pair, a particular QP, or other communication in a particular storage, such that related congestion events 115 are stored together. In some such implementations that operate with RDMA, a portion of a QP identifier (QP ID), such as low-order bits of the QP ID, may be used to select a storage. In other implementations, an identity of a PCIe function associated with the QP, congestion control algorithm running in connection with the QP, and/or other information regarding a QP may be used to select a storage.

In some implementations, the event handler 120 may choose when to provide congestion events 115 to event processor 125 for processing. The event handler 120 may provide congestion events 115 to the event processor 125 in a time sequence in some implementations or at some times, such that congestion events 115 are processed by event processor 125 in an order in which they are generated. As another example, event handler 120 may be configured in accordance with a congestion control algorithm with information regarding related congestion events 115, and may provide to the event processor 125 a congestion event 115 when it has been generated together with related congestion events or when a set of related congestion events 115 has been generated, such as generated within a time range. Implementations are not limited to a particular manner in which event handler 120 may provide congestion events to event processor 125.

Examples of the event handler 120 include, without limitation, cores, logic units, microprocessors, microcontrollers, Field-Programmable Gate Arrays (FPGAs) that implement softcore processors, Application-Specific Integrated Circuits (ASICs), portions of one or more of the same, variations or combinations of one or more of the same, or any other suitable physical processor. In some implementations, the event handler 120 can include software applications, firmware, or programs that, when executed by a circuit, integrated circuit, computing device, CPU, or GPU, can perform one or more tasks.

The event processor 125 can receive and process the congestion events 115 from the event handler 120. The event handler 120 can process congestion events 115, either alone or together and in accordance with one or more congestion control algorithms with which the event handler 120 is configured, to identify congestion in the network 105. As mentioned above, such congestion may be in only part of the network(s) 105 and may be detected in association with one or more connections/communications and not other connections/communications. As should be appreciated from the description here, some implementations are able to detect and control congestion arising within a host (e.g., within a network device, such as within a transmit or receive data path), which may arise even in a case that there is no network congestion. The event processor 125, per the congestion control algorithm(s) with which it is configured, may analyze congestion events 115 alone or together, to identify from a congestion event or one or more combinations of congestion events (e.g., particular combinations of particular types of congestion events), whether congestion in the network is present. In response to detecting congestion in association with a communication/connection, the event processor 125 may update state information 128 for the communication/connection. In addition, some congestion events 115 may indicate that congestion that was previously detected is no longer present, and in response to detecting that congestion is no longer present, the event processor 125 may update state information 128 to indicate as such. Based on the state information 128, one or more other components of the network device 102 or host 100 may react to adjust communication over the network(s) 105 based on the presence or absence of congestion.

Examples of the event processor 125 include, without limitation, processors, cores, logic units, microprocessors, microcontrollers, Field-Programmable Gate Arrays (FPGAs) that implement softcore processors, Application-Specific Integrated Circuits (ASICs), portions of one or more of the same, variations or combinations of one or more of the same, or any other suitable physical processor. In some implementations, the event processor 125 can include software applications, firmware, or programs that, when executed by a circuit, integrated circuit, computing device, CPU, or GPU, can perform one or more tasks.

Accordingly, in some implementations in which operations of congestion control are performed in hardware using hardware circuits 110, other operations related to congestion control may be performed in software executing on one or more processors implementing functionality of event handler 120 and/or event processor 125.

FIGS. 2A-2B illustrate example systems 200, 202 with which some implementations can operate. Similar elements are labeled with corresponding numbers and labels from FIG. 1. Some functionality of elements shown in FIGS. 2A-2B is also described below in connection with FIGS. 4-6.

FIG. 2A illustrates an example of a system 200 that may be implemented within a network device, such as a network interface card (NIC), an example of which is network device 102 of FIG. 1. FIG. 2A illustrates examples of congestion event (CE) sources (e.g., hardware circuits 110) that generate receive (RX) CEs (e.g., packet events 115A), counter CEs, timer CEs (e.g., timer events 115C), and control CEs (e.g., control events 115D). For example, the counter Ces can be free-running counts of various operations maintained on a per-connection basis such as a number of packets received or a number of bytes transmitted. In another example, the counter Ces can be a type of the connection events 115B. The CEs can be received by the CE DMA (e.g., event handler 120) and can be delivered via DMA to the CE processing (e.g., event processor 125). In other implementations, a network device may be configured to exchange CE information using memory mapped input/output (MMIO) in addition to or as an alternative to DMA. As shown in FIG. 2A, the CE Processing (e.g., event processor 125) may include multiple CPUs to execute instructions (e.g., software instructions) to process CEs in accordance with one or more congestion control algorithms. Accordingly, a network device (e.g., a NIC) may have disposed on it multiple CPUs that may be configured to perform congestion control algorithms, including by configuring hardware sources of CEs (e.g., hardware circuits 110) to generate CEs upon satisfaction of specified conditions and by processing such CEs to detect congestion and to regulate network communication based on whether congestion is detected. As illustrated in FIG. 2A, CE Processing may perform data path control to control a path of data through MMIO operations. Such operations may include updating state information for communications/connections based on whether CEs were determined, in accordance with a congestion control algorithm, to indicate presence of congestion, and/or to adjust network communication (e.g., adjust transmission rate or window size) based on whether such congestion was detected.

FIG. 2A did not illustrate in detail components of an event handler (e.g., event handler 120). The system 202 of FIG. 2B provides a more detailed view of some components of a network device (e.g., network device 102) in some implementations.

The CE sources on the left-hand size of FIG. 2B can be implemented similarly to the hardware circuits 110 of FIG. 1 and the CE sources of FIG. 2A. For example, RXPP can be implemented to generate RX CEs in the same manner as packet receiver 110A is implemented to generate packet events 115A, or that RX CEs are generated; QP Counters can be implemented to generate CTR CEs in the same manner as connection handler 110B is implemented to generate connection events 115B, or that Counter CEs are generated; timers can be implemented to generate TMR CEs in the same manner as connection timers 110C is implemented to generate timer events 115C, or that Timer CEs are generated; and firmware can be implemented to generate CTL CEs in the same manner as firmware controller 110D is implemented to generate control events 115D, or that Control CEs are generated.

As shown in FIG. 2B, a control handler 120 of some implementations may include CE Buffering and an arbiter and scheduling. CE Buffering may include a congestion event hash that determines a function block from among multiple function blocks (64 function blocks in the example of FIG. 2B) to which to assign an incoming congestion event (CE). As shown in FIG. 2B, each function block may include multiple queues, at least one for each type of congestion event. A function block may, in some cases, be a queue group. In some implementations, a queue group may be a group of queues that are associated with a given Peripheral Component Interconnect (PCI) function, which may be a PCIe function. The CE Hash may assign congestion events to function blocks in a round-robin fashion, may assign all congestion events for a communication/connection (e.g., for an RDMA QP) to the same function block over time (and/or assigning congestion events for different QPs to different function blocks over time), may load balance CEs between function blocks or between queues, or may use other approaches to buffering CEs for subsequent processing by the CE Processing (e.g., event processor 125). Each of the function blocks may be implemented as a circuit and may include storage (e.g., caches, registers, FIFOs, or other storages) to hold CEs.

FIG. 2B illustrates that the event handler 120 also includes an arbiter and scheduler, which chooses CEs from the storages of the function blocks to pass to CE Processing for processing. The arbiter and scheduler of the event handler 120 may be configured in accordance with an arbitration policy, such as a Congestion Event Queue Group (CEQP) policy, and/or a function scheduling policy, which informs how CEs are chosen for forwarding. The policy/policies used by the arbitration and scheduling may in some cases be set based on a congestion control algorithm, such that CEs are selected and processed in accordance with the congestion control algorithm. As discussed above in connection with FIG. 1, in some cases CEs may be selected for processing in accordance with an order in which they were generated, such that CE Processing processes the CEs in the order in which the CEs were generated. In other cases CEs may be selected for processing together, such as when a congestion control algorithm indicates that a CE may indicate congestion when in the presence of another CE of another type. Various ways of selecting CEs for provision to the CE Processing may be used, as implementations are not limited in this respect. In some implementations, the manner in which CEs are provided to CE Processing may be changed over time, such that the configuration may be changed in accordance with a congestion control algorithm or other configuration. In some implementations, changing the configuration of the arbiter and scheduler of the event handler 120 may also include configuration of the CE Buffering, such that the manner in which function blocks and/or queues are chosen for storage of a CE may change over time. In some implementations, the CE Buffering and the arbiter and scheduler may be separately configurable.

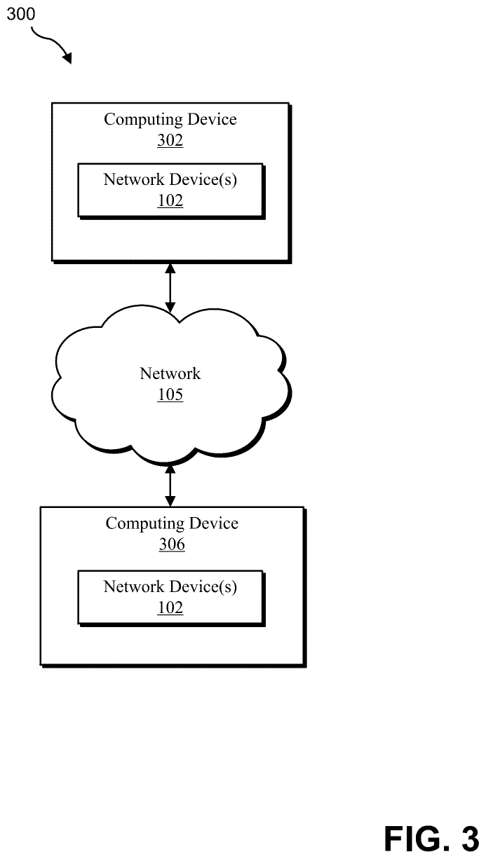

Example host 100 in FIG. 1 and systems 200, 202 in FIGS. 2A-2B can be implemented in a variety of systems. For example, all or a portion of host 100, system 200, and/or system 202 can represent portions of system 300 in FIG. 3. As shown in FIG. 3, system 300 can include a computing device 302 in communication with a computing device 306 via a network 105 (which may be one or more networks 105). In one example, all or a portion of the functionality of host 100 can be performed by either or both of the computing devices 302, 306, and/or any other suitable computing system. As will be described in greater detail below, one or more components from FIGS. 2A-2B can, when executed by at least one processor of computing devices 302 and/or 306, enable devices 302 and/or 306 to perform configurable congestion monitoring and/or control.

As should be appreciated from the foregoing, computing device 302, 306 generally represents any type or form of computing device capable of reading computer-executable instructions. As illustrated in FIG. 3, either or both of the devices 302, 306 can include one or more network devices 102. For example, the network device 102 can be or include an integrated circuit or a network interface card (NIC) or other network interface hardware, such as a network interface to provide connectivity (e.g., communication) between a host of the network interface and a network. Examples of computing devices 302, 306 include, without limitation, laptops, tablets, desktops, servers (rack-mounted or otherwise), cellular/smart phones, Personal Digital Assistants (PDAs), multimedia players, embedded systems, wearable devices (e.g., smart watches, smart glasses, etc.), smart vehicles, so-called Internet-of-Things devices (e.g., smart appliances, etc.), gaming consoles, variations or combinations of one or more of the same, or any other suitable computing device. In some implementations, a computing device can be or include storage servers, database servers, application servers, and/or web servers configured to run certain software applications and/or provide various storage, database, and/or web services.

As should be appreciated from the foregoing, network 105 generally represents any medium or architecture capable of facilitating communication or data transfer. In one example, network 105 can facilitate communication between computing device 302 and computing device 306. In this example, network 105 can facilitate communication or data transfer using wireless and/or wired connections. Examples of network 105 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, or any other suitable network.

Many other devices or subsystems can be connected to host 100 in FIG. 1, systems 200, 202 in FIGS. 2A-2B, and/or system 300 in FIG. 3. Conversely, all of the components and devices illustrated in FIGS. 1-3 need not be present to practice the implementations described and/or illustrated herein. The devices and subsystems referenced above can also be interconnected in different ways from that shown in FIG. 1-3. Host 100 or systems 200, 202, and 300 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, generally refers to any form of device, storage, non-transitory medium, non-transitory computer-readable, or medium capable of storing or carrying computer-readable instructions. Examples of computer-readable media or non-transitory computer-readable media include non-transitory type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other non-transitory or distribution systems.

FIG. 4 is a flow diagram of an example computer-implemented method 400 for configuring a network device to perform configurable congestion monitoring and/or control in accordance with techniques descried herein. The steps shown in FIG. 4 can be performed by any suitable circuit, computer-executable code and/or computing system, including host 100 in FIG. 1, system 200 in FIG. 2, system 300 in FIG. 3, and/or variations or combinations of one or more of the same. In one example, each of the steps shown in FIG. 4 can represent a circuit or algorithm whose structure includes and/or is represented by multiple sub-steps, examples of which will be provided in greater detail below.

As illustrated in FIG. 4, at step 402, one or more of the systems described herein can configure hardware circuits to generate congestion events indicative of congestion in a network. For example, as part of step 402, the event processor 125 can, as part of host 100 in FIG. 1, configure the hardware circuits 110 to generate the congestion events 115 indicative of congestion in the network 105. As another example, the host 100 can configured the hardware circuits 110 to generate the congestion events. The systems described herein can perform step 402 in a variety of ways. The configuration of step 402 may be performed during an initialization and/or at runtime.

The configuration of step 402 may be performed in accordance with a congestion control algorithm with which an event processor 125 and/or an event handler 120 is to be configured. For example, a new or updated congestion control algorithm may be being loaded by the network device 102 after being received from an entity over the network and/or received from processor 106 of FIG. 1. In some cases, a process executing on processor 106 may receive information regarding the congestion control algorithm from an entity over a network and/or from a user (e.g., an administrator) of host 100 and update a configuration of the network device 102, which may include directly configuring the hardware circuits 110 from the process of the processor 106. In other cases, a process executing on the processor 106 may receive the congestion control algorithm information (e.g., from the network and/or from a user) and configure the event processor 125 (or other component of the network device 102), which may in turn configure the circuits 110 consistent with the congestion control algorithm. In still other cases, the event processor 125 may receive the congestion control algorithm configuration information from over the network 105 from another entity and perform the configuration without involvement of the processor 106. In some cases in which a congestion control algorithm is received over a network or from a user, parameters of the congestion control algorithm may be set based on user input, such as certain values for the congestion control algorithms. In some implementations, one or more parameters of the congestion control algorithm may be set using information obtained in or derived from processing past congestion events.

Information regarding a congestion control algorithm may in some cases include information on rules with which hardware circuits 110 may be configured to perform operations related to congestion control. Parameters of the rules, such as conditions of the rules, may be specified in the information that is received from a network entity and/or a user of host 100. Configuration of step 402 may proceed in accordance with the information regarding the congestion control algorithm.

Accordingly, in some implementations, the event processor 125 can configure the hardware circuits 110 with one or more rules that, when satisfied, cause the hardware circuits 110 to generate congestion events 115 indicative of congestion in the network 105. In some implementations, the event processor 125 can define a fixed set of rules to support generation of the congestion events 115. The rules can be enabled at configuration time. In some implementations, logically, rules can be enabled on a per-QP basis. In some implementations, the event processor 125 can separate out the storage required for rules in groups, per-QP, per-function or any other arrangement, such as to provide desired flexibility and/or reduce storage overhead. In some implementations, the event processor 125 can configure the hardware circuits 110 with rules that can be enabled or disabled while a QP is in operation.

In some implementations, the event processor 125 can define the rules with one or more properties. In some implementations, the event processor 125 can assign the rules to one or more classes. For example, the event processor 125 can assign the rules to Receive Packet Rules (RPR) for generating packet events 115A. In another example, the event processor 125 can assign the rules to QP Counter Rules for generating connection events 115B. In another example, the event processor 125 can assign the rules to Timer Rules (TR) for generating timer events 115C. In another example, the event processor 125 can assign the rules to Control Rules for generating control events 115D. In some implementations, the event processor 125 can assign groups of related rules in a class are logically grouped into the same category.

In some implementations, the event processor 125 can generate rules of one or more types. For example, Condition-Value (CVAL) rules can set a condition and value evaluated every time the logic for the rule is executed. An action can occur when the evaluated property meets the provided condition and value. Examples of conditions include relational operators such as >, >=, <, <=, ==, !=(does not equal), % (sample). The % operator can be used to sample events and can cause an action to occur every value occurrences. In some implementations, only a subset of conditions may be applicable for a given rule. The value can be an integer, floating point number, string, or other value, and the type of value may vary between rules.

The event processor 125 can configure the hardware circuits 110 to perform an action that can occur if the rules are satisfied. For example, if an enabled rule is satisfied, an action can be to create a congestion event 115. In another example, if an enabled rule is satisfied, a HW Offload such as a fixed HW operation can occur.

In another example, rearm semantics can define HW rule re-enablement when a rule fires. Rules can be defined to have one or more semantics. For example, the semantic can be immediate re-enable so that the rule can be immediately re-enabled after firing. In another example, the semantic can be delayed re-enable so that the rule is ignored for a user configurable ignore timeout period or number of events after which it is re-enabled. In another example, the semantic can be one shot so that the rule is disabled after firing. Rules can be defined to support multiple potential actions, however, when enabled, a rule can be limited to executing only one of a set of supported actions. In some implementations, the event processor 125 can configure the rules on the hardware circuits 110 via rule evaluation logic embedded throughout the data and control path. Accordingly, in some implementations the rules that are active for a communication and/or for a connection may change over time and may change while the communication is ongoing, in response to applicable conditions for the rules being met or not met. As a result, the congestion event rules may be dynamic and changing. For example, in response to a condition being met a rule may be enabled, where that rule adds or modifies a trigger for generation of a congestion event, such that after the rule is enabled a congestion event may be generated in circumstances that (prior to the rule enablement) would not have generated a congestion event.

In some implementations, the event processor 125 can configure the packet receiver 110A to generate packet events 115A. In some implementations, the event processor 125 can configure the packet receiver 110A to detect packets that match properties and events that signal congestion. In some implementations, the event processor 125 can configure the packet receiver 110A to generate packet events 115A.

In some implementations, the event processor 125 can configure the packet receiver 110A with rules to generate the packet events 115A. For example, the rules can be packet thresholds. In some implementations, the event processor 125 can configure the packet receiver 110A to generate the packet events 115A in response to detecting one or more packet parameters of one or more packets received over the network 105 that satisfy one or more packet thresholds. In some implementations, the event processor 125 can configure the one or more packet thresholds of the packet receiver 110A. For example, the packet parameters can be round trip time (RTT) and the packet thresholds can be a maximum RTT. When packets have an RTT that exceeds the maximum RTT, the event processor 125 can configure the packet receiver 110A to generate packet events 115A indicative of congestion.

In some implementations, the event processor 125 can configure the packet receiver 110A to evaluate, for every received packet, the rules for the QP. In some implementations, the event processor 125 can configure the packet receiver 110A to generate, if the packet matches one or more of the rules, the packet events 115A and queue them for processing. In some implementations, the event processor 125 can configure the packet receiver 110A to generate the packet events 115A to include the results of the evaluation of the rules.

In some implementations, the event processor 125 can configure the packet receiver 110A to identify a delay between generating and processing the packet events 115A. For example, the delay can be indicative of congestion in network device 102. In another example, the delay can be a fill level in a buffer of the packets received by the packet receiver 110A. In some implementations, the event processor 125 can configure the packet receiver 110A to generate packet events 115A with timestamps that identify the time at which the packet events 115A were generated. The event processor 125 can use the timestamps to identify the time at which the packet events 115A were generated. In some implementations, the event processor 125 can identify the time at which the packet events 115A were provided to the event processor 125 for processing. The event processor 125 can identify the delay between generating and processing the packet events 115A as the time between the time at which the packet events 115A were generated and the time at which the packet events 115A were provided to the event processor 125. In some implementations, the event processor 125 can store and/or record the delay per connection. In some implementations, the event processor 125 can configure the packet receiver 110A to generate packet events 115A in response to the delay exceeding a threshold.

In some implementations, the event processor 125 can configure the packet receiver 110A with rules in categories such as RDMA Transport, Explicit Congestion Notification (ECN), RTT, and one-way latency. In some implementations, the event processor 125 can configure the packet receiver 110A to enable per-QP Receive Packet Rules on QP initialization. For example, the rules can be per-QP rules. In some implementations, the event processor 125 can configure the packet receiver 110A to have the rules may be enabled by default, unavailable or automatically enabled or disabled depending on which other rules have been enabled.

One example rule is to create the packet events 115A for every new received RDMA Request packet. Another example rule is to create the packet events 115A for every new received RDMA packet that has a predetermined opcode such as opcode b10001 (Acknowledge) or b10010 (ATOMIC Acknowledge). Another example rule is to create the packet events 115A for every new received RDMA READ RESPONSE (First, Middle, Last, Only). Another example rule is to create the packet events 115A for every received RDMA packet that matches the one or more rules. One example rule is if the packet is not an acknowledgment packet (e.g., NAK). Another example rule is if the packet is a duplicate READ RESPONSE packet. Another example rule is if the packet is a duplicate acknowledgment (e.g., ACK) packet. Another example rule is if the packet is a duplicate RDMA Request packet.

Another example rule is to create the packet events 115A for every received RDMA congestion notification packet (CNP). Another example rule is to create the packet events 115A for every packet received from a certain IP address, a given MAC address, UDP or TCP port parameters, or other characteristics. Another example rule is to create the packet events 115A for every received packet that includes a bit set to indicate that congestion was encountered. Another example rule is to create HW Offload actions to send a signal regarding congestion to another node on the network, such as a transmitter of a communication. Such HW Offload action may be generating a congestion event, generating a notification packet regarding congestion to be transmitted over the network, or other action. Another example rule is to create the packet events 115A if the request-to-response RTT matches user-provided CVAL. Another example rule is to create the packet events 115A if remote-to-local one-way delay (OWD) matches user-provided CVAL. Another example rule is to create HW Offload actions to reflect OWD congestion signal to peer via RPR HO. Another example rule is to create the packet events 115A based on the queueing delay. Another example rule is to create the packet events 115A based on the fill level in a buffer of the packets received by the packet receiver 110A. Other example rules to create the packet events 115A can be based on RTT and/or in-band network telemetry (INT).

In some implementations, the event processor 125 can configure the connection handler 110B to generate connection events 115B. In some implementations, the event processor 125 can configure the connection handler 110B to generate the connection events 115B in response to detecting one or more connection parameters in one or more connections in the network 105 that satisfy one or more connection thresholds. For example, the connection parameters can include a maximum number of transmitted bytes and the connection thresholds can be a maximum number of bytes to transmit. When a connection transmits too many bytes, the event processor 125 can configure the connection handler 110B to generate connection events 115B indicative of congestion. For example, the event processor 125 can configure the connection handler 110B to generate connection events 115B if the transmit byte count exceeds the threshold or if the receive byte count exceeds threshold.

In some implementations, the event processor 125 can configure the connection handler 110B with one or more connection thresholds for one or more parameters. For example, the event processor 125 can configure the connection handler 110B with a condition and/or value to generate the connection events 115B when the count matches the condition and/or value. For example, the connection parameters can be QP events, values, and properties. In another example, the connection parameters can be a number of bytes transmitted or number of packets received. In some implementations, the event processor 125 can configure the connection handler 110B to count QP events, values, and properties of interest. In some implementations, the event processor 125 can configure the connection handler 110B to count a number of bytes transmitted. In some implementations, the event processor 125 can configure the connection handler 110B to count a number of packets received. In some implementations, the event processor 125 can set, update, and delete the counters of the connection handler 110B.

In some implementations, the event processor 125 can configure the connection handler 110B with counters to trap and react to changes in the QP's counter state. In some implementations, the event processor 125 can configure the connection handler 110B to generate connection events 115B with congestion state (e.g., of QP) and processing state. In some implementations, the event processor 125 can configure the connection handler 110B to generate connection events 115B when specific counters match a connection threshold (e.g., CVAL). In some implementations, the counters can be one-shot like floating timers. In some implementations, the event processor 125 can configure the connection handler 110B to evaluate the provided connection threshold at every point in the data path where the counter changes. In some implementations, the event processor 125 can configure the connection handler 110B to generate the connection events 115B when the threshold is satisfied (e.g., CVAL is TRUE). In some implementations, the event processor 125 can configure the connection handler 110B with positive or negative connection thresholds. In some implementations, the event processor 125 can configure the connection handler 110B to stop monitoring the connection thresholds (e.g., counter) after generating the connection events 115B.

In some implementations, the event processor 125 can configure the connection timers 110C to generate timer events 115C. In some implementations, the event processor 125 can configure the connection timers 110C to generate the timer events 115C in response to detecting one or more connection times for one or more connections in the network 105 that satisfy one or more time-conditions. In some implementations, the event processor 125 can configure the one or more time-conditions of the connection timers 110C. For example, the connection times can be how long a connection is idle and the time-condition can be a timer representing a maximum time during which the connection can be idle. The event processor 125 can configure the connection timers 110C to generate timer events 115C when the timer expires.

In some implementations, the event processor 125 can configure the connection timers 110C with one or more programmable timers. In some implementations, the event processor 125 can configure the connection timers 110C with time-conditions that are timers that count down from a provided value and generate timer events 115C if they expire. In some implementations, the event processor 125 can configure the connection timers 110C to set, update, and/or deleted the timers. In some implementations, the event processor 125 can configure the connection timers 110C with updates to existing and/or set timers.

In some implementations, the event processor 125 can configure the connection timers 110C to generate timer events 115C with the connection (e.g., QP) and processing state. In some implementations, the event processor 125 can configure the connection timers 110C with trapping system timers through per-QP Timer Rules. In some implementations, the event processor 125 can configure the connection timers 110C to generate timer events 115C for every send response timeout. In some implementations, the event processor 125 can configure the connection timers 110C by configuring the hardware with rules.

In some implementations, the event processor 125 can configure the connection timers 110C with floating timers. In some implementations, the event processor 125 can configure the resolution and range of the floating timers. In some implementations, the event processor 125 can allocate a timer from a floating timer pool. In some implementations, the event processor 125 can update a timer when an allocated timer is re-primed with a new timeout value. In some implementations, the event processor 125 can query timers of the connection timers 110C, such as to obtain the current countdown value of the allocated timer.

In some implementations, the event processor 125 can configure the connection timers 110C with floating timers that are one-shot. In some implementations, the event processor 125 can configure the connection timers 110C such that if a floating timer expires, the timer events 115C are generated and queued in the appropriate queue and/or the timer is freed and returned to the pool of available floating timers. In some implementations, the event processor 125 can configure the connection timers 110C to assign identifiers to the timers. For example, floating timers are identified by a system-wide unique Timer Identifier (TimerID). In some implementations, the event processor 125 can configure the connection timers 110C to include the identifiers of the timers in the timer events 115C. In some implementations, the event processor 125 can query the timers by their identifiers (e.g., to identify how much time is left in the timers of the connection timers 110C). In some implementations, the event processor 125 can store the identifiers of the timers of the connection timers 110C.

In some implementations, the event processor 125 can configure the firmware controller 110D to generate control events 115D. In some implementations, the event processor 125 can configure the firmware controller 110D to generate the control events 115D in response to detecting one or more control signals of one or more connections in the network 105. For example, the event processor 125 can configure the firmware controller 110D to generate the control events 115D in response to initializing a queue pair. In some implementations, the firmware controller 110D can generate control events 115D that identify signals that control the connections. For example, the control events 115D can indicate initialization of the connections. In some implementations, the firmware controller 110D can generate control events 115D that identify the configuration of the connections.

In some implementations, the event processor 125 includes code for configuring the hardware circuits 110. In some implementations, the event processor 125 includes firmware for configuring the hardware circuits 110. In some implementations, the event processor 125 includes software for configuring the hardware circuits 110. In some implementations, the event processor 125 updates the code with instructions for configuring the hardware circuits 110 with the one or more rules.

In some implementations, the event processor 125 can generate and/or configure hardware constructs. In some implementations, the event processor 125 can generate and/or configure hardware constructs to identify congestion in the remote peer and in the network 105. In some implementations, the event processor 125 can generate and/or configure hardware constructs to access and update packet fields and QP state. In some implementations, the event processor 125 can generate and/or configure hardware constructs to set, update, and delete hardware timers and counters. In some implementations, the event processor 125 can generate and/or configure hardware constructs to start, stop and update QP transmission rates. In some implementations, the event processor 125 can configure hardware congestion control algorithms. The algorithms can be based on Explicit Congestion Notification (ECN) markings, round trip time (RTT), and one-way latency.

As illustrated in FIG. 4, at step 404, one or more of the systems described herein can receive, from the hardware circuits, congestion events indicative of the congestion in the network. For example, as part of step 404, the event handler 120 can, as part of host 100 in FIG. 1, receive, from the hardware circuits 110, congestion events 115 indicative of the congestion in the network 105. The systems described herein can perform step 404 in a variety of ways.

In some implementations, the event handler 120 can receive the congestion events 115 generated by the hardware circuits 110 based on one or more network signals in the network 105 satisfying the one or more rules with which the hardware circuits 110 were configured by the event handler 120. In some implementations, the event handler 120 can receive the packet events 115A from the packet receiver 110A. For example, the event handler 120 can receive the packet events 115A from the packet receiver 110A when a received packet matches one-or-more congestion detection rules. In some implementations, the event handler 120 can receive the connection events 115B from the connection handler 110B. For example, the event handler 120 can receive the connection events 115B from the connection handler 110B when a QP counter matches a supplied condition and value. In some implementations, the event handler 120 can receive the timer events 115C from the connection timers 110C. For example, the event handler 120 can receive the timer events 115C from the connection timers 110C when a hardware timer fires. In some implementations, the event handler 120 can receive the control events 115D from the firmware controller 110D. For example, the event handler 120 can receive the control events 115D from the firmware controller 110D in response to firmware actions.

In some implementations, the event handler 120 can configure the packet receiver 110A to generate packet events 115A based on the control events 115D. For example, after receiving the control events 115D that identify a QP, the event handler 120 can configure the packet receiver 110A to parse, after receipt of every packet, the packet for this QP and identify if it matches one or more of the congestion detection rules for the QP. If the packet matches one or more congestion detection rules, the packet receiver 110A can generate the packet events 115A and provide them to the event handler 120.

As illustrated in FIG. 4, at step 406, one or more of the systems described herein can analyze the one or more congestion events to address the congestion in the network. For example, as part of step 406, the event handler 120 can, as part of host 100 in FIG. 1, analyze the congestion events 115 to address the congestion in the network 105. The systems described herein can perform step 406 in a variety of ways.

In some implementations, in response to receipt of the congestion events 115 from the plurality of hardware circuits configured with the one or more rules to detect the congestion in the network 105, the event handler 120 can analyze the congestion events 115 to address the congestion in the network 105. In some implementations, the event handler 120 can analyze the congestion events 115 to identify whether the congestion events 115 can be transmitted to the event processor 125. In some implementations, the event handler 120 can provide the congestion events 115 to the event processor 125 for processing.

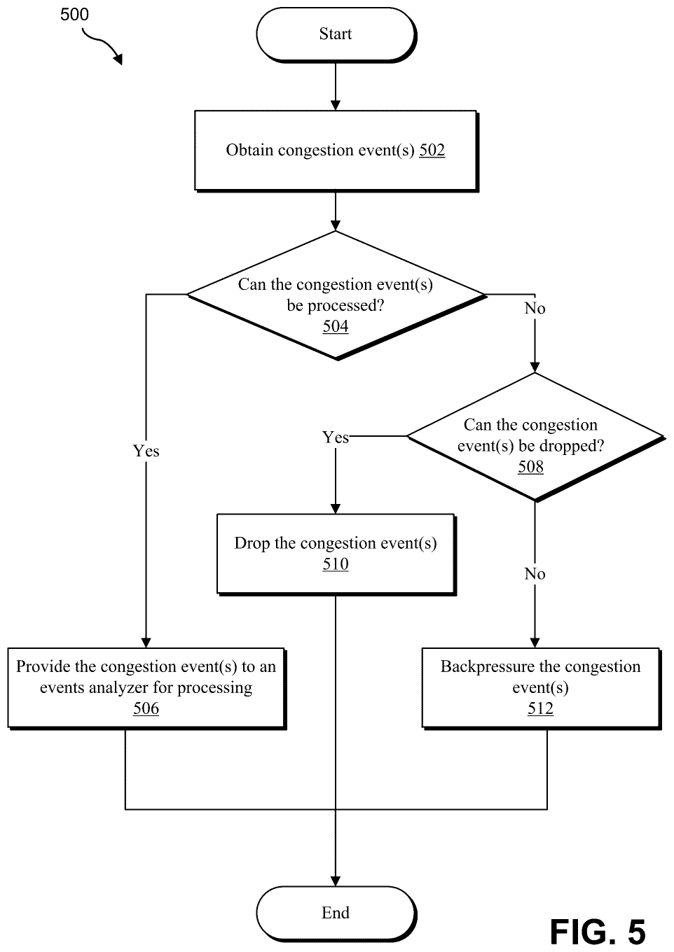

FIG. 5 is a flow diagram of an example computer-implemented method 500 for handling congestion events. The steps shown in FIG. 5 can be performed by any suitable circuit, computer-executable code and/or computing system, including host 100 in FIG. 1, system 200 in FIG. 2, system 300 in FIG. 3, and/or variations or combinations of one or more of the same. In one example, each of the steps shown in FIG. 5 can represent a circuit or algorithm whose structure includes and/or is represented by multiple sub-steps, examples of which will be provided in greater detail below.

As illustrated in FIG. 5, at step 502, one or more of the systems described herein can identify congestion events. For example, as part of step 502, the event handler 120 can, as part of host 100 in FIG. 1, identify the congestion events 115 indicative of congestion in the network 105. The systems described herein can perform step 502 in a variety of ways.

In some implementations, the event handler 120 can identify the congestion events 115 generated by the hardware circuits 110. In some implementations, the event handler 120 can identify the packet events 115A from the packet receiver 110A. In some implementations, the event handler 120 can identify the connection events 115B from the connection handler 110B. In some implementations, the event handler 120 can identify the timer events 115C from the connection timers 110C. In some implementations, the event handler 120 can identify the control events 115D from the firmware controller 110D.

As illustrated in FIG. 5, at step 504, one or more of the systems described herein can identify whether the congestion events can be processed. For example, as part of step 504, the event handler 120 can, as part of host 100 in FIG. 1, identify whether the congestion events 115 can be processed by the event processor 125. The systems described herein can perform step 504 in a variety of ways.

In some implementations, the event handler 120 can identify, in the congestion events 115, a memory address in the event processor 125 to which the congestion events 115 are addressed for storage. In some implementations, the event handler 120 can map congestion events 115 to destination memory of the event processor 125. In some implementations, the event handler 120 can utilize direct memory access (DMA) to provide the congestion events 115 to destination memory of the event processor 125. For example, the event handler 120 can include a DMA block to examine the congestion events 115 to determine delivery address in the memory of the event processor 125.

In some implementations, the event handler 120 can maintain statistics that may be queried by the event processor 125. For example, the event handler 120 can maintain statistics of delivered and dropped congestion events 115 on a per-function basis, such as the functions (e.g., queue groups) illustrated in FIG. 2B. In some implementations, the event handler 120 can track the state of descriptor and completion rings. In some implementations, the event handler 120 can raise interrupts to the event processor 125. In some implementations, the event handler 120 can receive memory mapped input/output (MMIO) doorbells from the event processor 125. For example, the event processor 125 can inform the event handler 120 of how much memory is available on the event processor 125. For example, the event processor 125 can indicate available memory as the event processor 125 processes and/or consumes the congestion events 115.

In some implementations, the event handler 120 can receive the congestion events 115 from a data and control path. In some implementations, the event handler 120 can handle the congestion events 115 in the order they are received (e.g., first in first out). In some implementations, the event handler 120 can logically maintains an instance of an identifier for every event queue. The identifier can be used in the TX and RX data paths.

In some implementations, the event handler 120 can, for each of the congestion events 115, map the queue pair identifier (QP ID) associated with the congestion events 115 to an active QP ID (AQPID) if one is not already active. The allocation can be static such as picking the congestion queue from the lower of the QP ID or dynamic such as picking the congestion queue that has the smallest sum of all AQPID references.

If the AQPIDs are unavailable (e.g., memory is unavailable) to map the congestion events 115, the event handler 120 can determine in step 504 that a congestion event cannot be processed.

As discussed in further detail below in connection with steps 510, 512, the event handler 120 may backpressure or drop the congestion events 115 in response to determining in step 504 that an event cannot be processed. For example, if the destination queue (or the queues of a queue group, such as queues of a function of FIG. 2B) is full, the hardware circuits 110 can be backpressured (e.g., prevent congestion events 115 from being generated and/or transmitted) until a slot becomes available if the congestion events 115 cannot be dropped (e.g., deleted). In another example, the packet events 115A can be dropped if the storage is unavailable. The event handler 120 can log the drop. The event handler 120 can increment the AQPID's reference count after mapping the congestion events 115. In some implementations, the event handler 120 can decrement the AQPID reference count by writing a processing structure to the appropriate control window.

The event handler 120 can perform a QP fetch to retrieve the QP Context information required for the CE. This information can include congestion control state and/or QP configuration and working state. The event handler 120 can provide the AQPID with the congestion events 115 to the event processor 125. In some implementations, the event handler 120 can update QP state by writing a message to the appropriate control window.

In some implementations, the computer-implemented method 500 proceeds to step 506 if the event handler 120 identifies that the congestion events 115 can be processed by the event processor 125. In some implementations, the event handler 120 can identify, based on availability of the memory address, to forward the congestion events 115 to the event processor 125 for processing the congestion events 115 to address the congestion in the network 105. For example, the event handler 120 can identify to forward the congestion events 115 if there is enough memory on the event processor 125 to receive them. In some implementations, there may be multiple events processors 125 in a system to which a congestion event may be sent for processing. In some such implementations, the event handler 120 may choose from among the multiple event processors 125 an event processor 125 to which to send a congestion event. For example, the event handler 120 may choose an event processor 125 using a load balancing approach by reviewing information regarding load of one or more or all of the event processors 125. In some implementations that include multiple event processors 125, an event handler may send congestion events for a connection or for a communication between two or more nodes to an event processor 125 that previously processed congestion events for that connection/communication. Implementations are not limited to operating with any particular approach to selecting an event processor 125 in implementations that include multiple event processors 125. Some implementations may additionally or alternatively include multiple event handlers 120 and the system may similarly choose a handler 120 to which to send a congestion event.

In some implementations, the computer-implemented method 500 proceeds to step 508 if the event handler 120 identifies that the congestion events 115 cannot be processed by the event processor 125. In some implementations, the event handler 120 can identify, based on unavailability of the memory address, to not forward the congestion events 115 for processing the congestion events 115 by the event processor 125.

As illustrated in FIG. 5, at step 506, one or more of the systems described herein can provide the congestion events to the congestion detector for processing. For example, as part of step 504, the event handler 120 can, as part of host 100 in FIG. 1, provide (e.g., forward) the congestion events 115 to the event processor 125 for processing. The systems described herein can perform step 506 in a variety of ways.

For example, the event handler 120 can transmit the congestion events 115 to the event processor 125 via DMA. In another example, the event handler 120 can provide the congestion events 115 to the event processor 125 via a data path.

As illustrated in FIG. 5, at step 508, one or more of the systems described herein can identify whether the congestion events can be dropped. For example, as part of step 508, the event handler 120 can, as part of host 100 in FIG. 1, identify whether the congestion events 115 can be dropped from the event handler 120. The event handler 120 may in some implementations determine whether an event can be dropped by determining whether a packet corresponding to the event had a “DROP” flag set indicating whether it was permissible to drop the packet or a related congestion event. As another example, the event handler 120 may in some implementations determine whether an event can be dropped by determining whether a configuration of the network device 102 indicates that dropping of events is permitted. As a further example, in some implementations dropping of congestion events on the receive side of communications may be permitted, but dropping transmit side congestion events may not be permitted. As another example, in some implementations certain types of congestion events (e.g., timer events or control events) may not be dropped but other event types may be dropped. The systems described herein can perform step 508 in a variety of ways.

In some implementations, the computer-implemented method 500 proceeds to step 510 if the event handler 120 identifies that the congestion events 115 can be dropped. In some implementations, the computer-implemented method 500 proceeds to step 512 if the event handler 120 identifies that the congestion events 115 cannot be dropped.

As illustrated in FIG. 5, at step 510, one or more of the systems described herein drop the congestion event(s). For example, as part of step 510, the event handler 120 can, as part of host 100 in FIG. 1, drop the congestion events 115. The systems described herein can perform step 510 in a variety of ways.

In some implementations, the event handler 120 can delete the congestion events 115. In some implementations, the event handler 120 can only drop congestion events 115 of a certain type. For example, the event handler 120 can only drop packet events 115A.

As illustrated in FIG. 5, at step 512, one or more of the systems described herein can backpressure the congestion events. For example, as part of step 512, the event handler 120 can, as part of host 100 in FIG. 1, backpressure the congestion events 115. The systems described herein can perform step 512 in a variety of ways.

In some implementations, the event handler 120 can cause the hardware circuits 110 to prevent generation of the congestion events 115. In some implementations, the event handler 120 can only cause the hardware circuits 110 to prevent generation of congestion events 115 of a certain type. For example, the event handler 120 can only configure the connection handler 110B, the connection timers 110C, and the firmware controller 110D to prevent generation of the congestion events 115.

In the example of FIG. 5, some congestion events are dropped when they cannot be processed. This may occur silently in some implementations, which no notification to other system components regarding the dropped congestion event and no storage and subsequent use of information regarding the dropped congestion event. In other implementations, there may be notifications and/or stored information regarding dropped congestion events. For example, in some implementations, in response to a drop of one or more congestion events in an event that there is not sufficient capacity to process a congestion event, information may be stored indicating that a congestion event was dropped. Implementations are not limited to storing any particular information or type of information. In some cases, the information may indicate that at least one congestion event was dropped, or may indicate a number of congestion events that were dropped. In some cases, information indicating the type(s) of dropped congestion events may be stored. In some cases, information regarding dropped congestion events may be maintained on a per communication or per-connection basis, such as for a particular queue pair (QP) in a case that RDMA is used. In implementations that store information regarding dropped congestion events, in response to a subsequent detection that capacity is available for processing congestion events, some or all of the stored information may be made available to the event handler and/or event processor. In some such cases, the information may be passed to the event handler and/or event processor along the data path for congestion events. In other cases, the information may be accessible by the event handler and/or event processor, and the event handler or event processor may retrieve the information if configured to do so. In cases in which information regarding dropped congestion events is stored, the information may be used by an event handler and/or event processor as part of handling or processing congestion events, such as in making a determination of whether congestion is present or responding to congestion. Implementations are not limited to a particular manner in which to process information regarding dropped congestion events.

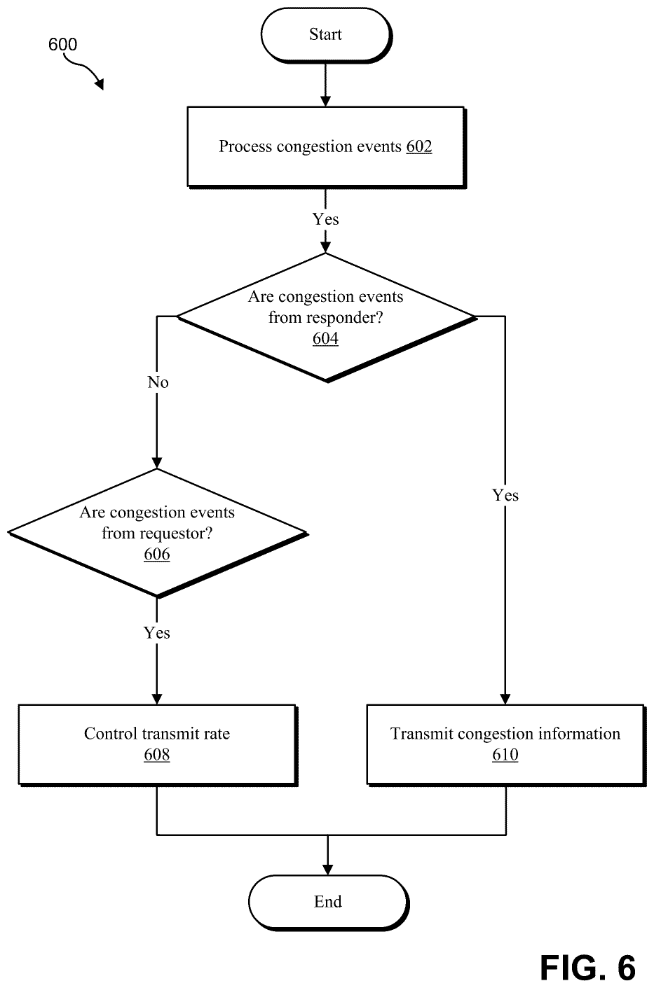

FIG. 6 is a flow diagram of an example computer-implemented method 600 for processing congestion events for programmable, hardware-accelerated congestion monitoring and/or control using hardware and software components. The steps shown in FIG. 6 can be performed by any suitable circuit, computer-executable code and/or computing system, including host 100 in FIG. 1, system 200 in FIG. 2, system 300 in FIG. 3, and/or variations or combinations of one or more of the same. In one example, each of the steps shown in FIG. 6 can represent a circuit or algorithm whose structure includes and/or is represented by multiple sub-steps, examples of which will be provided in greater detail below.

As illustrated in FIG. 6, at step 602, one or more of the systems described herein can process congestion events. For example, as part of step 602, the event processor 125 can, as part of host 100 in FIG. 1, process the congestion events 115 from the event handler 120 to address the congestion in the network 105. The systems described herein can perform step 602 in a variety of ways.

In some implementations, the event processor 125 can include several central processing units (CPUs) for processing the congestion events 115. In some implementations, the processing of the congestion events 115 by the event processor 125 is asynchronous to data path processing. In some implementations, the CPU(s) of the event processor 125 processes the congestion events 115 in a run-to-completion manner. In some implementations, the event processor 125 handles arbitration and processing of congestion events 115.

In some implementations, the event processor 125 invokes congestion control algorithms for each of the congestion events 115. In some implementations, the event processor 125 can run a user-provided software algorithm to process the congestion events 115. In some implementations, the event processor 125 can execute arbitrary and/or bounded code. In some implementations, the event processor 125 can access and update the congestion events 115 and associated QP Context state. In some implementations, the event processor 125 can update the QP transmission behavior and rate. In some implementations, the event processor 125 can send messages to the firmware and/or the event handler 120. In some implementations, the event processor 125 can set and update timers and counters. In some implementations, the event processor 125 can arbitrate and schedule between congestion events 115.

As illustrated in FIG. 6, at step 604, one or more of the systems described herein can identify whether the congestion events are for a responder (e.g., receiver) side of a communication/connection. For example, as part of step 604, the event processor 125 can, as part of host 100 in FIG. 1, identify whether the congestion events 115 are for incoming packets or other incoming messages. The systems described herein can perform step 604 in a variety of ways.

In some implementations, the event processor 125 can identify whether the congestion events 115 are associated with the network device 102 acting as a responder or a requestor (e.g., sender). In some implementations, the computer-implemented method 600 proceeds to step 606 if the event processor 125 identifies that the congestion events 115 are not for incoming packets/messages or otherwise not for communication where the network device is acting as responder. In some implementations, the computer-implemented method 600 proceeds to step 610 if the event processor 125 identifies that the congestion events 115 are for a responder side of communication.

As illustrated in FIG. 6, at step 606, one or more of the systems described herein can identify whether the congestion events are for a requestor (e.g., transmitter) side of communication. For example, as part of step 606, the event processor 125 can, as part of host 100 in FIG. 1, identify whether the congestion events 115 are related to packets or other messages for which the network device was a transmitter/sender/requestor. The systems described herein can perform step 606 in a variety of ways.

In some implementations, the event processor 125 can parse the congestion events 115 to identify whether they are for packets/messages where the network device is acting as a requestor. In some implementations, the computer-implemented method 600 proceeds to step 608 if the event processor 125 identifies that the congestion events 115 are for a requestor side of communication.

As illustrated in FIG. 6, at step 608, one or more of the systems described herein can control the transmission rate or other react to congestion as a transmitter. For example, as part of step 608, the event processor 125 can, as part of host 100 in FIG. 1, control the transmission rate (e.g., prevent additional packets from being transmitted). The systems described herein can perform step 608 in a variety of ways.

In some implementations, the event processor 125 can select, responsive to identifying that the congestion events 115 are for packets/messages or a connection where the network device is acting as a requestor/sender, a transmission rate for a connection associated with the congestion events 115. For example, if the QP is acting as a requestor for the congestion events 115, the event processor 125 can use a hardware application programming interface (HW API) to control and/or select the QP's transmit rate. For example, the event processor 125 can perform transmit rate limiting by limiting the QP send rate. In another example, the event processor 125 can perform outstanding congestion window to limit maximum unacknowledged data.

In some implementations, the event processor 125 can generate, a congestion status based on processing the congestion events 115. In some implementations, the event processor 125 can transmit, the congestion status the hardware circuits 110 to indicate the congestion in the network 105.

As illustrated in FIG. 6, at step 610, one or more of the systems described herein can transmit congestion information. For example, as part of step 610, the event processor 125 can, as part of host 100 in FIG. 1, transmit congestion information. The systems described herein can perform step 610 in a variety of ways.

In some implementations, the event processor 125 can select, responsive to identifying that the congestion events 115 are for packets/messages or a connection where the network device is configured as a responder/receiver, signal (e.g., transmit one or more messages or other information) congestion in the network 105, such as that congestion has been detected or providing information about the congestion. Such signaling can be made to the requester/sender for a connection, in some implementations. For example, if the QP is acting as a responder for the congestion events 115, the event processor 125 can select to use a hardware application programming interface (HW API) to signal congestion information to a remote peer in the network 105. In some implementations, the event processor 125 can generate, a congestion status based on processing the congestion events 115. In some implementations, the event processor 125 can transmit, the congestion status the hardware circuits 110 to indicate the congestion in the network 105. The signaling to a requester/sender may be done in some implementations via one or more hardware circuits arranged to signal congestion to the requester/sender for a communication connection or to another remote node with which communication is being conducted.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of host 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of host 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, storage system, and/or network device among multiple customers (i.e., tenants). One or more of the modules described herein can also partition data and/or configuration information of a multi-tenant application for each customer such that one customer cannot access data and/or configuration information of another customer.

According to various implementations, all or a portion of host 100 in FIG. 1 can be implemented within a virtual environment. For example, the modules and/or data described herein can reside and/or execute within a virtual machine. As used herein, the term “virtual machine” generally refers to any operating system environment that is abstracted from computing hardware by a virtual machine manager (e.g., a hypervisor).

In some examples, all or a portion of host 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various implementations of the examples disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
at least one circuit configured to:
configure a plurality of hardware circuits with one or more rules that, when satisfied, cause the plurality of hardware circuits to generate one or more congestion events indicative of congestion in a network;
receive the one or more congestion events generated by the plurality of hardware circuits based on one or more network signals in the network satisfying the one or more rules; and
in response to the receipt of the one or more congestion events from the plurality of hardware circuits configured with the one or more rules to detect the congestion in the network,
analyze the one or more congestion events to address the congestion in the network.

2. The system of claim 1, wherein the at least one circuit is configured to configure the plurality of hardware circuits to generate the one or more congestion events at least in part by:
configuring at least one of the plurality of hardware circuits to output an indication of congestion in response to detecting that one or more packets received over the network satisfy one or more criteria.

3. The system of claim 1, wherein the at least one circuit is configured to configure the plurality of hardware circuits to generate the one or more congestion events at least in part by:
configuring at least one of the plurality of hardware circuits to output an indication of congestion in response to detecting that a connection satisfies one or more criteria.

4. The system of claim 3, wherein detecting that the connection satisfies the one or more criteria comprises analyzing a plurality of packets of the connection to determine that the one or more criteria are satisfied.

5. The system of claim 1, wherein the at least one circuit is configured to configure the plurality of hardware circuits to generate the one or more congestion events at least in part by:
configuring at least one of the plurality of hardware circuits to output an indication of congestion in response to a timer satisfying at least one criterion.

6. The system of claim 5, wherein the at least one circuit is configured to configure the plurality of hardware circuits at least in part by:
configuring the at least one of the plurality of hardware circuits to start the timer upon satisfaction of at least one second criterion.

7. The system of claim 1, wherein the at least one circuit is configured to configure the plurality of hardware circuits to generate the one or more congestion events at least in part by:
configuring at least one of the plurality of hardware circuits to generate a congestion event in response to detecting that one or more storages of the system, for storing information regarding messages communicated over the network, satisfy one or more criteria.

8. The system of claim 7, wherein detecting that the one or more storages of the system satisfy the one or more criteria comprises detecting that the one or more storages of the system are filled more than a threshold amount.

9. The system of claim 1, wherein the at least one circuit is configured to analyze the one or more congestion events at least in part by:
identifying, in the one or more congestion events, a storage in which the one or more congestion events are to be stored; and
when the storage is not available for storage of the one or more congestion events,
deleting the one or more congestion events, wherein the one or more congestion events are of a first type; or
triggering at least one of the plurality of hardware circuits to prevent generation of additional congestion events of a second type.

10. The system of claim 1, wherein the at least one circuit is further configured to:
transmit over the network to a source of one or more network communications an indication of congestion in the network, responsive to the one or more congestion events.

11. The system of claim 1, wherein the at least one circuit is further configured to:
provide to one or more of the plurality of hardware circuits information regarding the congestion, responsive to the one or more congestion events indicating congestion with respect to a connection over the network.

12. A network interface hardware to provide connectivity between a host and a network, the network interface hardware comprising:
at least one circuit configured to:
configure a plurality of hardware circuits with one or more rules that, when satisfied, cause the plurality of hardware circuits to generate one or more congestion events indicative of congestion in a network;
receive the one or more congestion events generated by the plurality of hardware circuits based on one or more network signals in the network satisfying the one or more rules; and
in response to the receipt of the one or more congestion events from the plurality of hardware circuits,
analyze the one or more congestion events to address the congestion in the network.

13. A system comprising:
the network interface hardware of claim 12; and
the host.

14. The network interface hardware of claim 12, wherein the at least one circuit is configured to analyze the one or more congestion events at least in part by:
identifying, in the one or more congestion events, a storage in which the one or more congestion events are to be stored; and
when the storage is not available for storage of the one or more congestion events,
deleting the one or more congestion events, wherein the one or more congestion events are of a first type; or
triggering at least one of the plurality of hardware circuits to prevent generation of additional congestion events of a second type.

15. The network interface hardware of claim 12, wherein configuring the plurality of hardware circuits to generate the one or more congestion events comprises:
configuring at least one of the plurality of hardware circuits to output an indication of congestion in response to detecting that a connection satisfies one or more criteria.

16. The network interface hardware of claim 12, wherein configuring the plurality of hardware circuits comprises:
configuring at least one of the plurality of hardware circuits to output an indication of congestion in response to a timer satisfying at least one criterion.

17. A method for congestion control, the method being performed with at least one circuit, the method comprising:
receiving one or more congestion events generated by a plurality of hardware circuits configured with one or more rules for generating the one or more congestion events in response to detecting one or more network signals in a network; and
in response to the at least one circuit not being able to process the one or more congestion events to address congestion in the network, dropping the one or more congestion events or modifying generation of additional congestion events.

18. The method of claim 17, wherein the at least one circuit is not able to process the one or more congestion events due to unavailability of memory to which the one or more congestion events are addressed for storage.

19. The method of claim 17, wherein the at least one circuit drops the one or more congestion events responsive to the one or more congestion events being of a first type that can be deleted, and wherein the at least one circuit configures the plurality of hardware circuits to modify the generation of the additional congestion events responsive to the one or more congestion events being of a second type that cannot be deleted.

20. The method of claim 17, wherein modifying the generation of the additional congestion events comprises modifying a generation rate of the additional congestion events.
